(19) United States
(12) Patent Application Publication
(10) Pub. No.: US 2007/0059152 A1
(43) Pub. Date: Mar. 15, 2007

(54) Methosand device for handling rod-shaped objects

(76) Inventor: Norbert Cottone, Zusmarshausen (DE)

Correspondence Address: MCGLEW & TUTTLE, PC, P.O. BOX 9227, SCARBOROUGH STATION, SCARBOROUGH, NY, 10510-9227, US

(21) Appl. No.: 10/596,634

(22) PCT Filed: Dec. 16, 2004
(86) PCT No.: PCT/EP04/14325

§ 371 Date: Jun. 19, 2006

(30) Foreign Application Priority Data
Dec. 20, 2003 (DE) 103 60 160.0

(51) Int. Cl. B65G 57/16

(52) U.S. Cl. 414/788.2

(57) ABSTRACT

The present invention proposes for the first time a completely automatable method for handling substantially rod-shaped objects, particularly poles of articles individually stacked in one another, such as plastic cups, for use e.g. in the dairy industry, during loading processes in conjunction with a loading aid, particularly a cardboard box or carton. The objects to be handled are made available in a first geometrical arrangement by a manufacturing or processing machine. The invention is characterized in that initially at least part of the objects is gripped, subsequently a relative arrangement of the objects is modified and the modified arrangement of the objects is deposited in the loading aid, the objects being arranged in upright standing manner. This makes it possible to achieve optimum packing densities for the objects in the loading aid. The invention also relates to a device suitable for performing said method.

The invention relates to a method for handling substantially rod-shaped objects, particularly poles of articles individually stacked in one another, such as plastic cups, during loading processes in conjunction with a loading aid, particularly a cardboard box or carton, in which the objects to be handled are made available in a first geometrical arrangement by a manufacturing or processing machine. The invention also relates to a device for handling substantially rod-shaped objects, particularly poles of articles individually stacked in one another, such as plastic cups, after being made available by a corresponding manufacturing or processing machine in a first geometrical arrangement during loading processes in conjunction with a loading aid, particularly a cardboard box or carton.

For receiving foods in the dairy industry, such as yogurt, milk drinks or the like, use is frequently made of cups of deep-drawn plastic sheets. Said cups are generally constructed in such a way that they can be stacked in one another. The rows of nested cups formed in this way are called cup poles hereinafter.

Following the manufacture of the cups in a corresponding deep-drawing machine in the form of cup poles are supplied directly to a further processing machine, such as a decorating machine for printing the cups and then packed in loading aids, particularly cartons for transportation, e.g. to a filling machine. It is also possible to pack in the loading aids directly following manufacture.

In known methods and devices of the aforementioned type the loading processes are performed in conjunction with a loading aid, which manually or in partly automated manner brings about the packing or unpacking of cup poles in or out of a carton. In general, the plastic cups are made from polypropylene (PP) or polystyrene (PS) in a thermal deep-drawing process. To this end an extruded sheet is supplied to the deep-drawing machine and heated therein, then preshaped by a prestretcher or preshaper and then finally e.g. using compressed air moulded in a mould, cooled and blanked. The finished, still hot and easily deformable cups are stacked in the deep-drawing machine (stacking of several cups in one another to form a cup pole) and are then either automatically supplied to a further processing machine for decoration (printing) or manually packed in a carton. For hygienic reasons the carton frequently has an inner lining in the form of a plastic bag.

Known methods and devices of the aforementioned type suffer from numerous disadvantages. Thus, hitherto no device is known enabling the performance of all the method steps required during the handling of rod-shaped objects, particularly the depositing in or removal from a loading aid in a fully automatic manner. In addition, in the known devices for the automatic packing of cup poles in loading aids in the case of changing to a new cup diameter of type there is a need for a time-consuming, costly resetting of the different machine components, so that a reduced variant flexibility results. In addition, most deep-drawing machines during each deep-drawing cycle produce not only a single cup, but simultaneously a plurality of individual cups on the basis of a specific pattern. This is generally two-dimensional and is called a cavity. As the transfer of the cups from the deep-drawing machine to the next handling or processing step, e.g. decorating or packing, generally takes place in the form of cup poles, i.e. single-dimensionally, a corresponding device must be integrated into deep-drawings machines enabling a cavity to be transformed into individual cup poles. This makes the corresponding deep-drawing machines more complicated and manufacture and maintenance are correspondingly more expensive.

Moreover, the transfer of cup poles in known deep-drawing machines generally takes place horizontally on the side. As a result of the sideways advance of the cup poles forces, such as weight and frictional forces, act on a sealing edge of the cups, which has a negative influence on the manufacturing quality of the cup, particularly since following deep-drawing the cups still have a temperature of 80øC and are consequently particularly easily deformable. The filling and sealing of a yogurt cup makes extremely high demands on said sealing edge or rim with respect to the tolerance, roundness and angular position relative to a cup axis, so that this prior art disadvantage is particularly serious.

Finally, in known methods and devices, specifically for packing cup poles in loading aids, such as cardboard boxes, it is not possible to adjust a packing pattern in the box in such a way that a maximum packing density can be achieved, i.e. a maximum number of cup poles per box.

DE 40 30 215 C2 discloses a device for handling, specifically removing, cup poles, which are supplied horizontally in an open transportation container. For this purpose the use of a suction member engaging the longitudinal side of the cup pole is disclosed. As stated hereinbefore, it is considered particularly disadvantageous that through the disclosed horizontal filling of the box or carton with cup poles an optimum packing density is not generally obtained. As a result of the force closure occurring between cups and suction member and due to the weight of the cup poles through which the lower layers in the carton are significantly loaded, the disclose device is unsuitable for handling still hot, deformable cups. In addition, the suction member of DE 40 30 215 C2 is only usable for cup poles having a fixed length.

DE 35 41 900 A1 discloses a method and a device for the layerwise displacement of poles of equal size, a gripper with a gripping fastening positively/non-positively grasping a plurality of parallel, horizontal cup poles and placing the same horizontally in cartons. This essentially leads to the same disadvantages as described relative to DE 40 30 215 C2.

DE 37 41 257 A1 discloses a gripping device, particularly for horizontal plastic cup stacks. Here again the cup poles are placed in superimposed, horizontal manner in loading aids. The disclosed gripping device also has one tong part and an engagement part cooperating therewith and as a result of which the stacks are grasped on their circumferential outer surface in the manner of gripping tongs. Once again the aforementioned disadvantages arise.

Finally, DE 34 24 233 C2 discloses a device for filling cartons, in which the cup poles are placed horizontally in cartons in a manner not described in detail using a gripping device. Thus, here again the aforementioned disadvantages occur.

The problem of the invention is to further develop a method and a device of the aforementioned type in such a way that a fully automatic handling of the cup poles, particularly a packing and unpacking in or out of a loading aid is possible using a carton which is closed on all sides, apart from one opening. In addition, during handling the cups must be treated particularly carefully, so that it is possible to handle the cups directly after their manufacture. In addition, the packing density of the cup poles within the loading aids is to be optimized.

The aforementioned problem is solved in a method of the aforementioned type in that firstly at least part of the objects is gripped, subsequently a relative arrangement of the objects with respect to one another is modified and then the modified arrangement of the objects is deposited in the loading aid, the objects standing upright.

In a device of the aforementioned type, for solving the set problem a first gripping device is provided for gripping at least part of the objects at an interface with the manufacturing or processing machine and for the upright depositing of the objects.

The objects handled according to the invention are in particular individual, separate objects, which are positively connectable, preferably stackable in one another and which can also hook together. As a result of the gripping action the objects are guided during further movement and are therefore moved from a predetermined position along a defined path, the orientation of the objects at each point being defined. After gripping the objects continue to be retained and consequently at least temporarily secured in a specific position and orientation. According to the invention the objects are moved radially and specifically during the spacing change or relative position change thereof, but not in the longitudinal direction. Thus, the position change takes place in an absolutely defined manner.

With the method and/or device according to the invention for the first time cup poles can be handled fully automatically in conjunction with a loading aid only open at one side, the handling of the cups being particularly careful and protective, particularly as a result of the upright depositing with a substantially vertical orientation of the cups or cup poles. On their circumferential surfaces the objects are embraced by retaining rods and a further end face is gripped by a securing mechanism. The objects are then transferred directly from the outlet unit to a handling unit, which are consequently in direct contact, without an intermediate stacking device being needed. Not only can the objects be moved into the handling unit, but the latter can be moved into the outlet unit. As a result a nesting or telescoping occurs and consequently there is an “interleaving” of the units, so that an absolutely reliable transfer of the objects is ensured. As a result of the inventive orientation of the cup arrangement, there is also an optimization of the object or cup number receivable within the loading means. According to the invention it is possible to have an arrangement of the objects with a high density and therefore high compactness.

The invention also permits the following:

The objects form a flexible, loose union of individual articles. In accordance with the inventive method the objects are embraced at their circumferential surface and this takes place by retaining rods located on the circumference. The objects can be “interleaved”, i.e. the centre spacing can be smaller than twice the radius. The actual securing of the objects during the handling process takes place frontally, namely on the “lower” face directed opposite to the gripper centre/gravity centre. Thus, in the method according to the invention the objects are positively gripped. The gripping system can be directly docked with the original unit. In addition, it is possible for engagement to take place in the original unit (retaining device), i.e. not only docking takes place. It is possible to handle a random part of the load of a loading aid, i.e. not only e.g. one row of objects.

According to a preferred development of the inventive method, the first gripping device is operated by a handling device, particularly a multiaxial industrial robot, which permits a particularly flexible usability of the gripping device. Correspondingly, in the device according to the invention, the first gripping device is operable by a handling device, particularly a multiaxial industrial robot. Preference is given to a four or six-axial industrial robot. The use of an industrial robot with a different number of axes is also possible.

For further optimizing the arrangement density in the loading aid, the present invention aims at adapting the first, original geometrical arrangement of the objects prior to the deposition thereof in the loading aid. According to the invention this can take place in two ways, but also a mixed form is possible.

Within the scope of the invention the objects can be gripped by means of a first gripping device and the modification to the object arrangement takes place by modifying a geometry of the first gripping device. However, it is also possible or additionally possible, prior to the deposition of the objects in the loading aid to deposit them in associated storage elements of magazine means, the arrangement geometry of the objects in said magazine means being modified. Thus, according to a further development of the inventive device the latter is set up in such a way that the first gripping device is constructed for modifying the geometry of the object arrangement prior to deposition in the loading aid and the magazine means are constructed for modifying the geometry of the object arrangement.

For a flexible variability of the geometry of the first gripping device, preferably each object of a (partial) cavity is gripped by an associated gripping element of the first gripping device and is retained by the same. According to a further development of the inventive device, in the first gripping device the latter has an associated gripping element for each object. Corresponding to the second, aforementioned development, the magazine means for each object can have an associated storage element.

As the rod-shaped objects to be handled are in particular not rigid objects, the gripping elements and/or storage elements preferably have according to a further development of the inventive device lateral guidance elements for the particular object held and into which, at least in the case of the gripping elements, can be integrated closure means for retaining the objects. To permit a particularly precise and space-saving deposition of the objects, according to a particularly preferred development of the inventive device, the guidance means are constructed for the parallel orientation of the rod axes of the objects.

To be able to achieve an optimum packing density in the loading aid, at least one group of gripping elements is arranged in one row. Correspondingly, with respect to the magazine means, the latter are constructed in an arrangement of rows for receiving objects with parallel rod axes and at least one group of storage elements is arranged in a row.

For the aforementioned reason, from the device standpoint at least the row-arranged gripping elements and/or storage elements of the particular group are movable, preferably in a direction perpendicular to the rod axis of the objects held, so that during the inventive method the sought change to the geometry of the first object arrangement can take place by modifying the spacing of the gripping elements and/or storage elements.

For this purpose the gripping and/or storage elements can be placed in sliding manner on a rail element extending in the direction of the row and according to a highly preferred development of the inventive device a lateral spacing of the gripping and/or storage elements from one another within the row is variable. According to a corresponding further development of the invention, with respect to the method, the spacing change takes place between a first given position on gripping the objects and a second position given by a sought packing density in the loading aid with regards to the gripping elements and/or storage elements.

In order to implement the inventively preferably possible change to the lateral spacing between the objects of a row between two said, predetermined positions in a constructionally simple manner, according to a highly preferred development of the inventive device the gripping and/or storage elements of the group are connected to the in each case adjacent gripping and/or storage element or elements by means of connecting means and as a result two relative positions with two different pairwise, lateral spacings of the gripping and/or storage elements are defined. By means of said connecting means a lateral movement of a gripping and/or storage element of the group can be transferred within specific, predetermined limits to the other gripping and/or storage elements of the group, so that preferably a single power source is sufficient for moving the gripping and/or storage elements for each group of gripping and/or storage elements.

In order to be able to implement the inventively sought optimum packing density in the loading aid also or in particular independently of a geometrical arrangement of the cups or cup poles in the cavity, it is generally necessary for the geometrical arrangement of the objects to be deposited in the loading aid to be composed substantially independently of the number and arrangement geometry of the made available objects/cavity. For this purpose the inventive device, as described hereinbefore, either has a first gripping device with movable gripping elements or (optionally also additionally) magazine means with movable storage elements for depositing the objects contained in the first gripping device. From the method standpoint, prior to depositing in the loading aid, either with an already modified geometry of the arrangement of the objects the latter are deposited in the magazine means or the geometry adaptation only takes place in the magazine means through movable storage elements. As stated, a mixed form of the two aforementioned method types is also possible. Moreover, following the geometry change in the first gripping device, the objects can be directly deposited therefrom in the loading aid.

With regards to the deposition of the objects in the loading aid, according to a preferred development of the inventive method, the objects in the form of a second arrangement can be removed from the magazine means using a second gripping device, so that preferably an inventive device has a second gripping device for removing a second geometrical arrangement of the objects from the magazine means. To achieve a rapid method sequence and in view of obtaining an optimum packing density in the loading aid, it is preferably constructed for a rowwise or blockwise removal of the objects from the magazine means. According to a corresponding method development of the invention removal from the magazine means takes place rowwise or blockwise. Preferably, as a result, one length of the rows corresponds to a dimension of the loading aid.

As for the first gripping device, the second gripping device is preferably operated by a handling device, particularly a multiaxial industrial robot. Within the scope of a corresponding development of the inventive method, it is also possible for the gripping device to be operated by a common handling device, particularly a multiaxial industrial robot. However, an operation of the gripping devices by different handling devices is also possible.

If the second gripping device has movable gripping elements, here again there can be an (optionally additional) geometry change of the object arrangement prior to the deposition of the objects in the loading aid.

In order to keep at their intended location in a secure and protected manner, also during transportation movements, the objects deposited in the loading aid, according to a highly preferred development of the inventive method, prior to the deposition of the objects a positioning insert is introduced into the loading aid. Correspondingly an inventive device preferably has a positioning insert placed in the loading aid and which in extremely preferred manner is located on the bottom of the loading aid. The provision of a positioning insert is particularly advantageous if the packing pattern of the objects within the loading aid can be changed during transportation, e.g. through sliding. The extent to which the positioning insert is to be provided on the bottom of the loading aid is dependent on the specific application. A possible alternative arrangement consists of a vertically positioned positioning insert in the form of a separating partition.

For receiving the objects the positioning insert, according to an extremely preferred development of the inventive device, has reception means for the objects constructed for the permanent spacing of the objects from at least one wall of the loading aid. According to the invention, the reception means can be so constructed and arranged that the objects with one of their rod ends can be brought into the reception means and in a preferred development of the inventive method the objects are brought into the reception means of the positioning insert with one of their rod ends and with mutually parallel rod axes. It must preferably be ensured that the objects are kept permanently spaced by the positioning insert from at least one wall of the loading aid. Preferably the positioning insert is constructed in such a way that it is possible to move below a deposited object, e.g. using a forked gripper, so that also cup poles in which the cup openings are directed downwards (towards the bottom of the loading aid) can be removed automatically from said loading aid.

As the method and device according to the invention must, in addition to the above-described packing of objects, also permit a fully automatic unpacking thereof from a loading aid, according to a preferred development of the inventive method at least one row of objects is positioned spaced from a wall of the loading aid extending parallel to the rod axes thereof for introducing a removal device into an area between the object row and the wall. Correspondingly in a device according to the invention, preferably the reception means for at least one row of objects is preferably arranged so as to bring about an optimum packing density of the objects. From the method standpoint, deposition in the loading aid can take place so as to achieve an optimum object packing density.

A removal of the objects deposited in the loading aid is sought or necessary, e.g. in conjunction with a further development of the inventive method, in which following the deposition of objects the loading aid is conveyed for further processing articles, such as e.g. their decoration or filling and to this end an inventive device preferably has conveying means for conveying the loading aid to a further processing device for the articles, e.g. a decorating or filling device. The inventive device then preferably has a further gripping device, together with handling device for the operation thereof and preferably an industrial robot, for removing the objects (removal device) from the loading aid, which in analogy to the second gripping device is constructed in preferred manner for the rowwise removal of the objects from the loading aid. From the method standpoint, according to corresponding developments of the inventive method, the objects for a further processing of the articles are removed by a further gripping device (removal device) from the loading aid and the removal preferably takes place in rows.

Alternatively the filled loading aids can be supplied to and stored in a storage device.

With respect to the inventive high degree dense and place-saving packing of the objects in the loading aid, according to a first development of the inventive device, the removal device has a clamping device for each object to be removed and is formed from an underengaging means for underengaging the object and a hold-down means for clamping the object between the underengaging means and the hold-down means, so that the objects can be removed from the loading aid by underengaging the objects with an underengaging means and clamping between underengaging means and hold-down means. Alternatively, for each object to be removed, the removal device has a shell arrangement formed from at least two partial shells rotatable relative to one another about a common axis for receiving the objects, the object being receivable in a space formed within the shell arrangement and is held therein by holding means provided at one end of the shell arrangement. Preferably the removal devices can be introduced into an area between the wall of the loading aid and the object row and which according to a corresponding development of the inventive positioning insert is to be kept permanently open.

Following the further processing of the articles, according to a preferred development of the inventive method, the objects are again placed in the loading aid and the objects can be removed by a common handling device, particularly a multiaxial industrial robot, from the loading aid and then placed therein again. A corresponding variant of the inventive device is characterized in that following the further processing of the articles, the objects can be placed back in the loading aid using a further gripping device, more particularly corresponding to the removal device.

So that the objects are mutually supported during the deposition in the loading aid, either after manufacture or after further processing, and even when filling is not complete, from the method standpoint the loading aid is inclined to the vertical during the deposition of the objects. The inclination of the loading aid takes place in an inventive device in a spreading or expanding station provided for this purpose, which also is mainly and preferably provided for spreading out a lining present in the loading aid and in particular a plastic bag during the deposition of the objects, accompanied by the simultaneous application thereof to the loading aid walls. As a result during the introduction of the packing/unpacking gripping device there are no collision points with the loading aid lining, because this could in particular damage the lining and subsequently hygienically impair the objects. A further function of the spreading station is the exact positioning of the loading aid during loading and unloading.

According to further developments of the inventive device, the removal device is operable by a handling device, particularly a multiaxial industrial robot. Correspondingly, a further gripping device can be operated by a corresponding handling device. In the case of a suitable timing of the further processing device, e.g. with respect to the work cycle or a geometrical design of the work area, it is also possible to operate the removal device and the further gripping device through a common handling device, particularly a multiaxial industrial robot. From the method standpoint, the objects can be removed by a first handling device, particularly a multiaxial industrial robot, from the loading aid and then, following further processing, can be placed back in it by a second handling device, particularly a multiaxial industrial robot.

If there are two handling devices at the further processing device, an inventive device preferably has conveying means for conveying the loading aid in a first cycle on the basis of a FIFO (first-in-first-out) principle from a work area of the first handling device into a work area of the second handling device during the further processing of the articles. From the method standpoint, correspondingly the loading aid during the further processing of the articles is conveyed during said cycle from one handling device to the other.

Further advantages and characteristics of the invention can be gathered from the claims and the following description of embodiments relative to the attached drawings, wherein show:

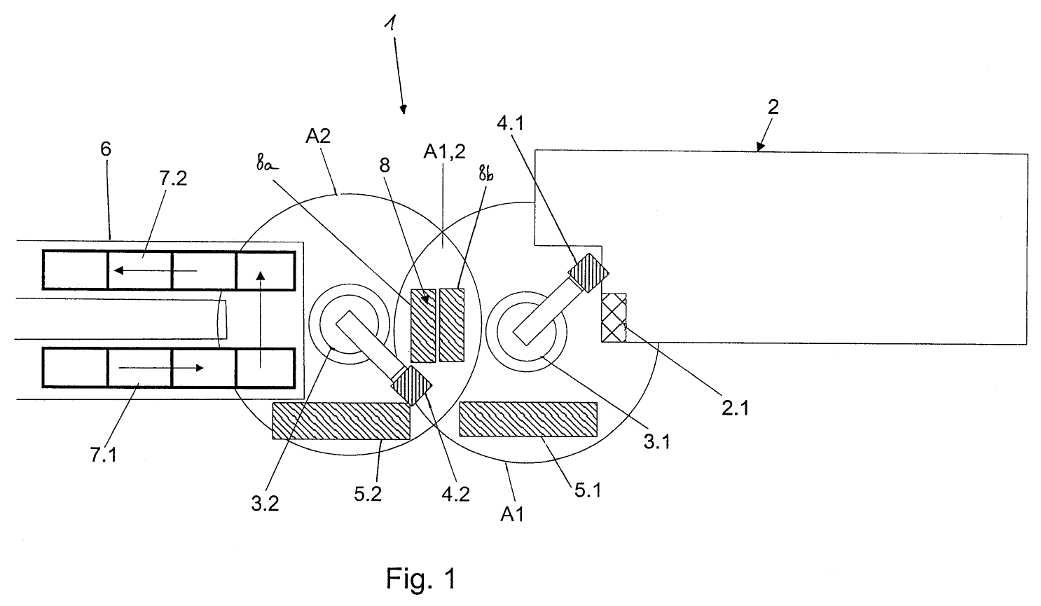

FIG. 1 A diagrammatic view of a development of the inventive device in connection with the manufacture and packing of plastic cups.

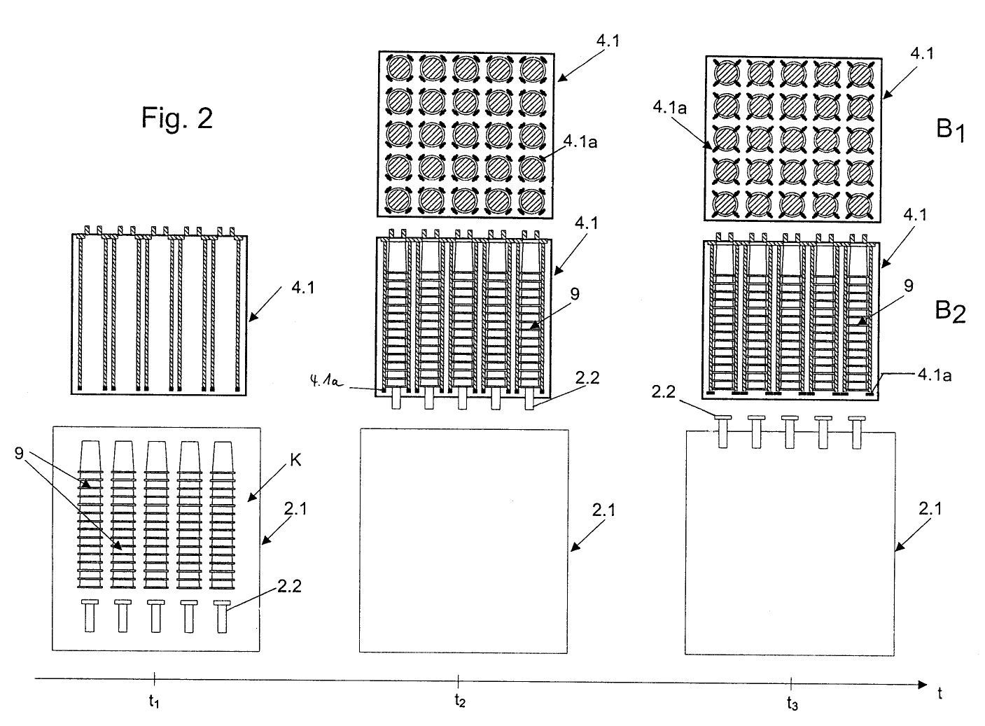

FIG. 2 Diagrammatic representations of the takeover of cup poles by a first gripping device.

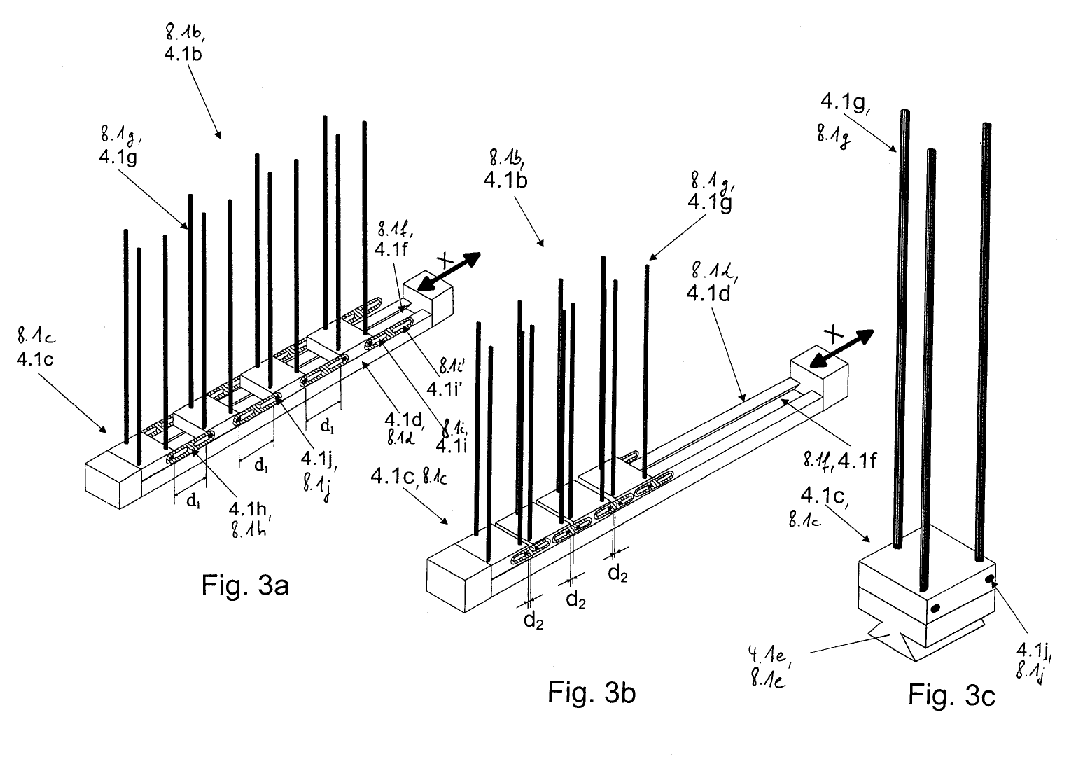

FIGS. 3a,b,c Detail views of a row of gripping elements of the first gripping device or corresponding storage means in the magazine means.

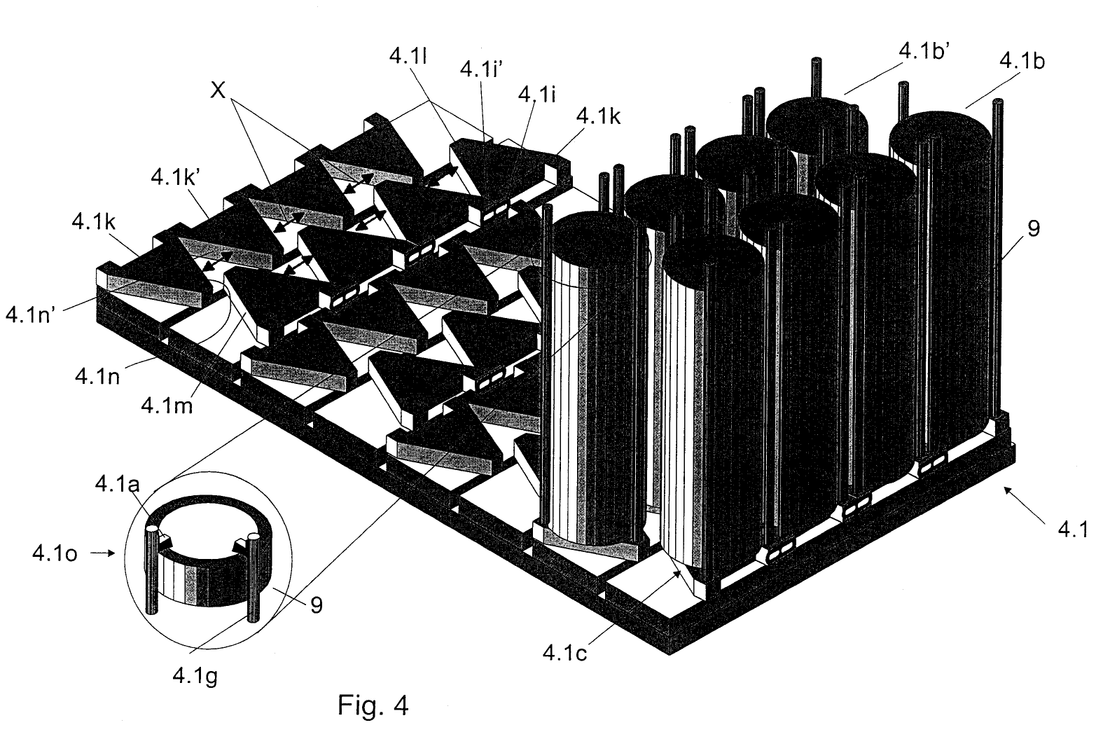

FIG. 4 A detailed overall view of the first gripping device.

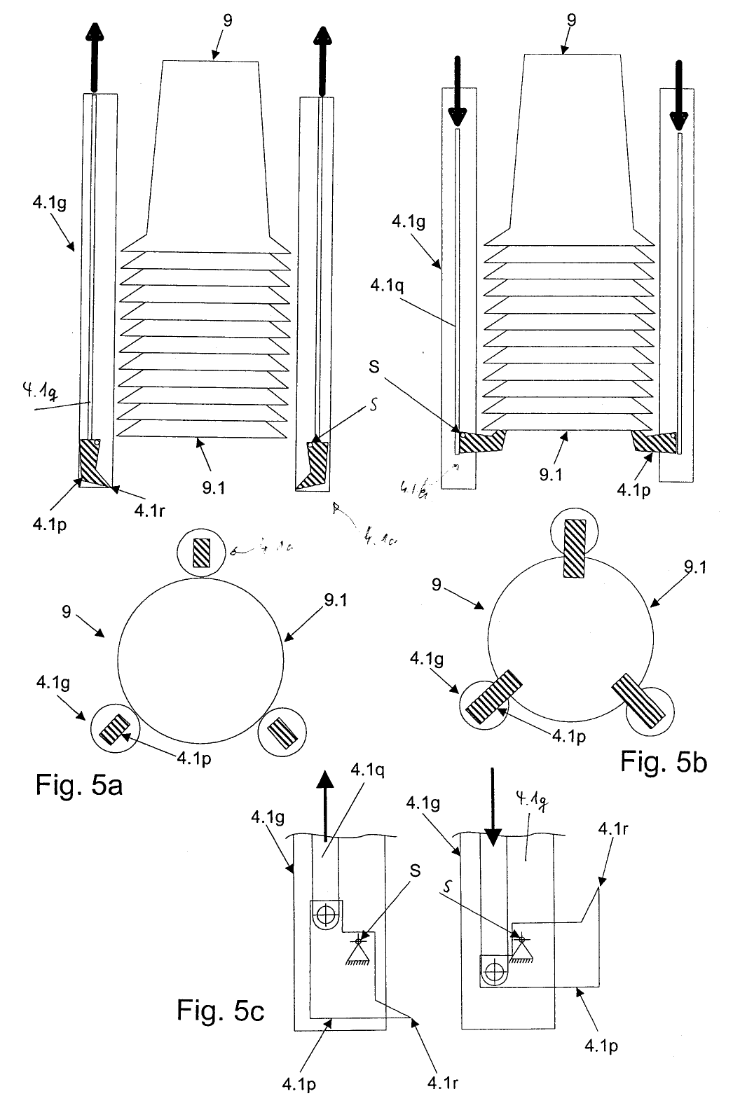

FIG. 5a,b,c Further diagrammatic detailed views of inventive gripping elements.

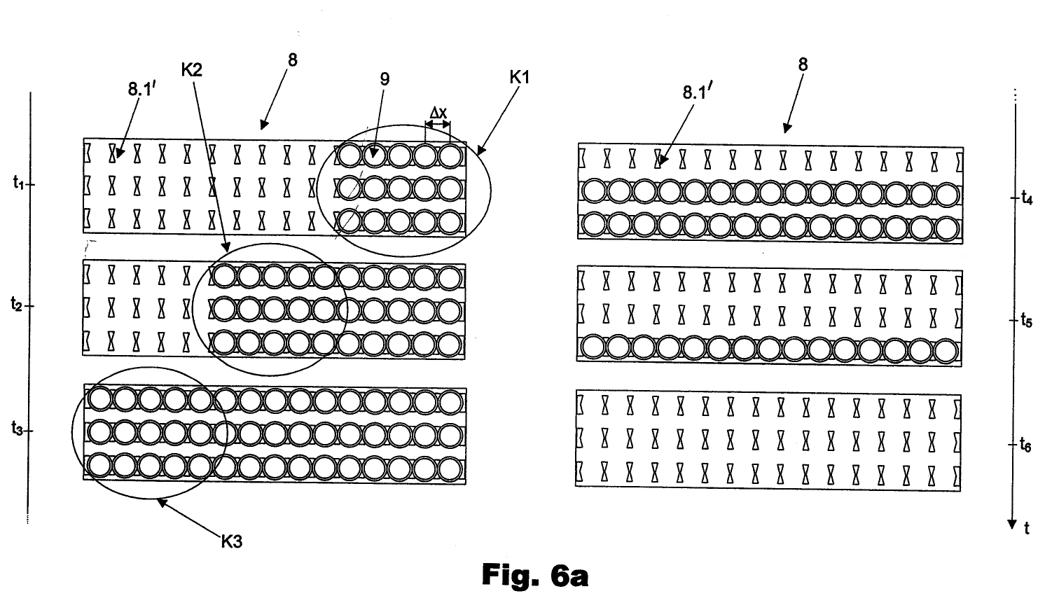

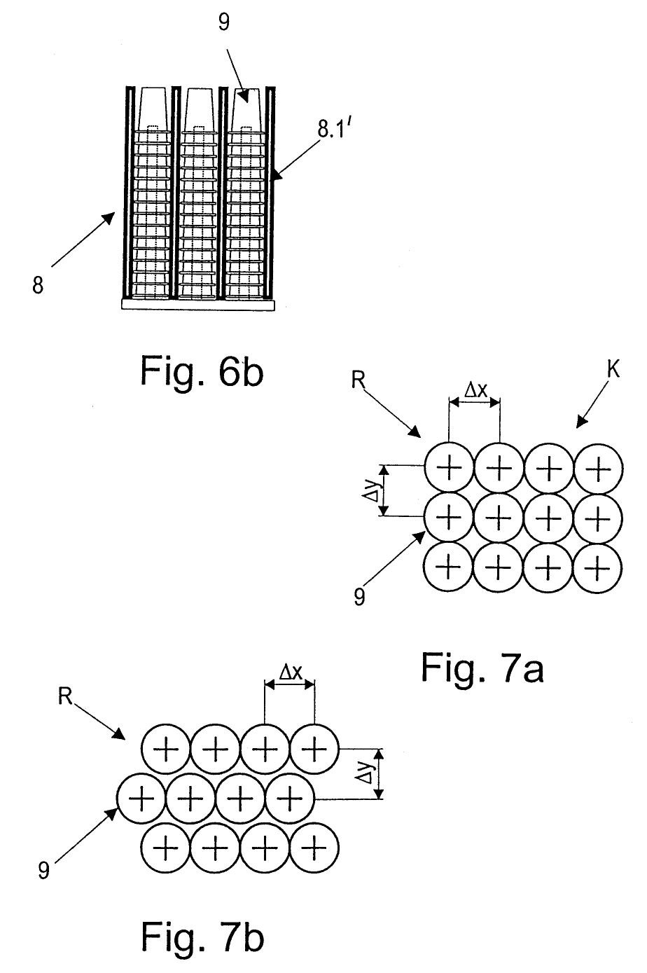

FIG. 6a Diagrammatic representations of the deposition and removal of objects in or from magazine means.

FIG. 6b Diagrammatic representation of a side view according to FIG. 6a.

FIG. 7a, b Diagrammatic representations of possible object packs in the loading aid.

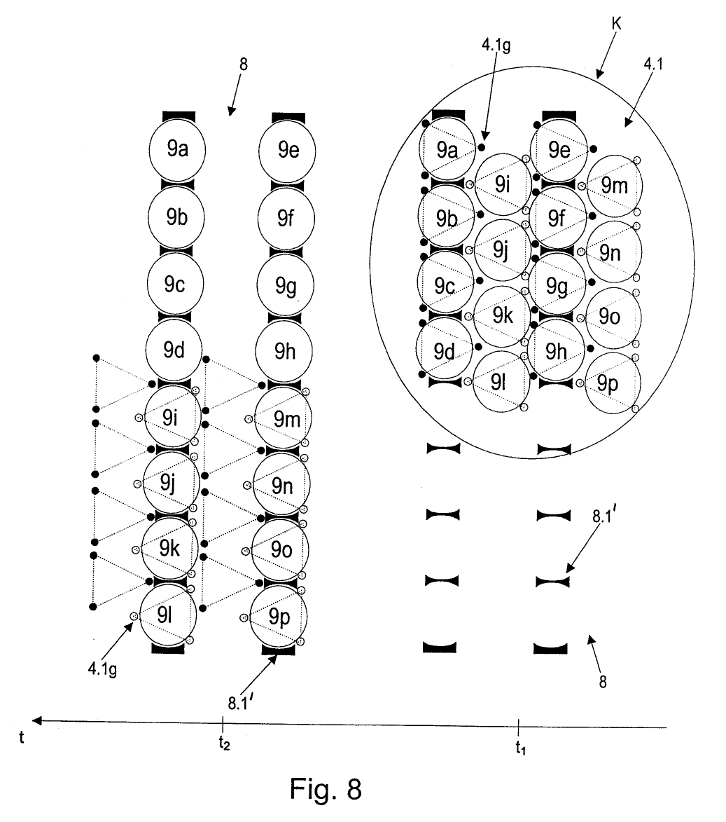

FIG. 8 Diagrammatic representations of a further procedure for depositing objects in the magazine means.

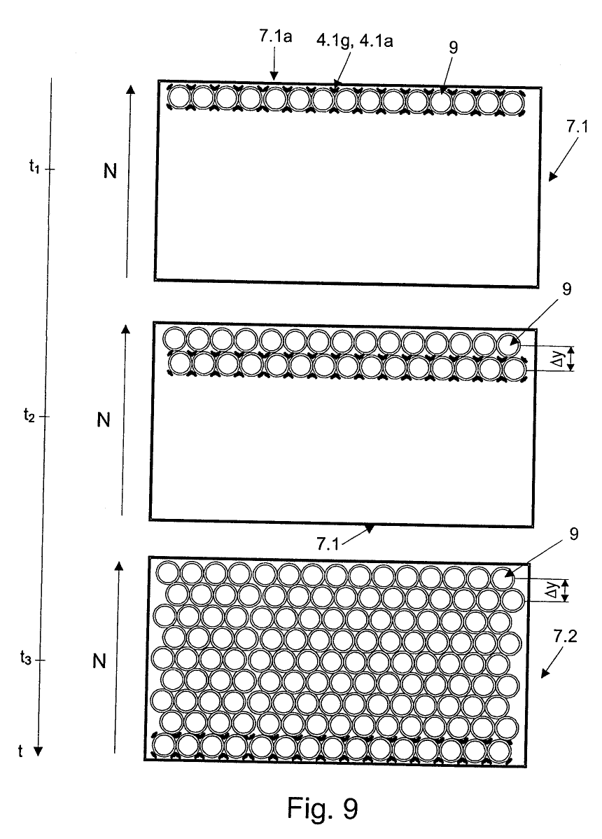

FIG. 9 Diagrammatic representations of the rowwise deposition of objects in the loading means.

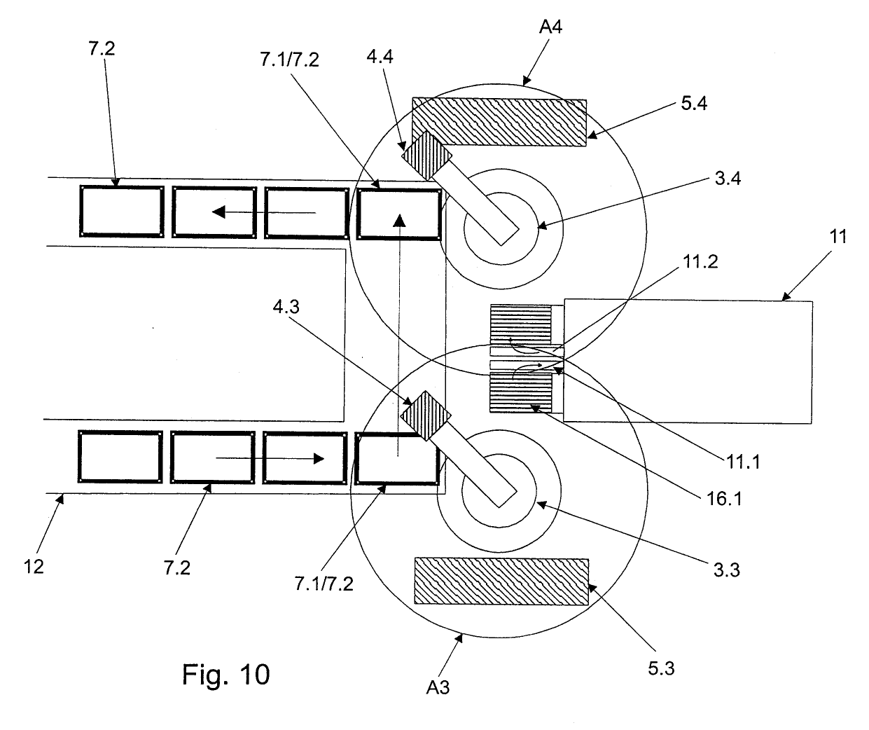

FIG. 10 A diagrammatic partial view of a development of the inventive device in connection with a further processing station for the articles.

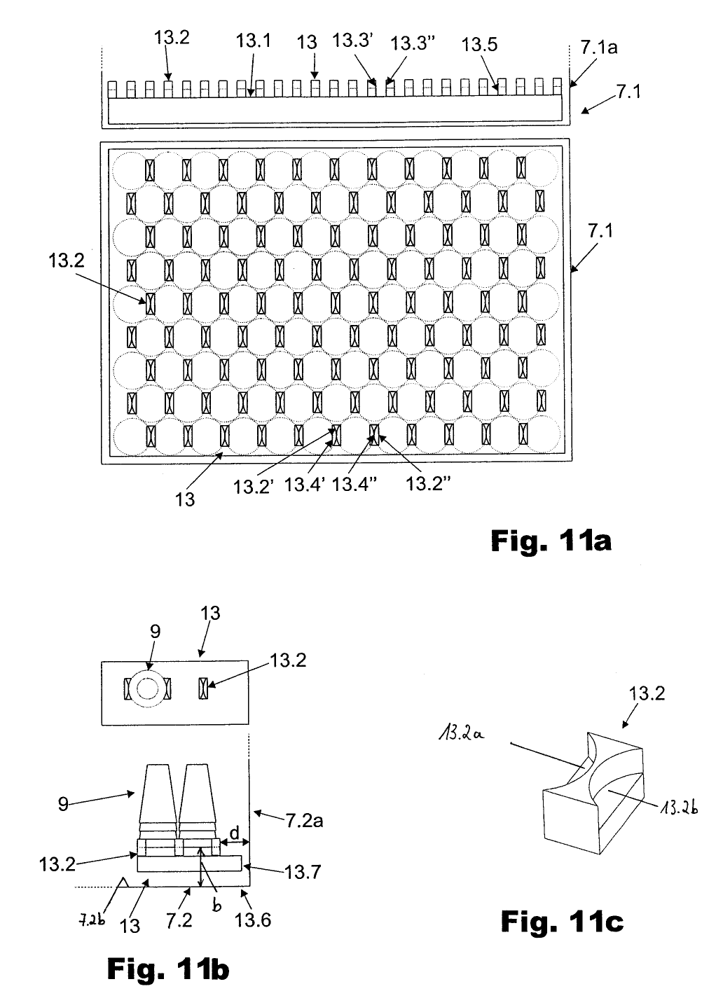

FIG. 11a Diagrammatic views of an inventive positioning insert.

FIG. 11b Partial views of an inventive positioning insert with objects placed thereon.

FIG. 11c A perspective view of a receiving means of the positioning insert.

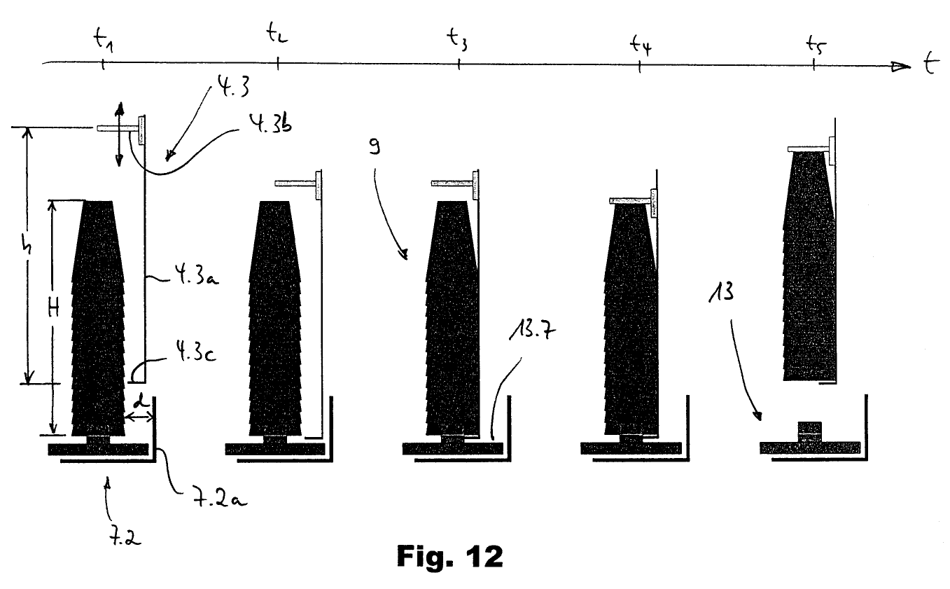

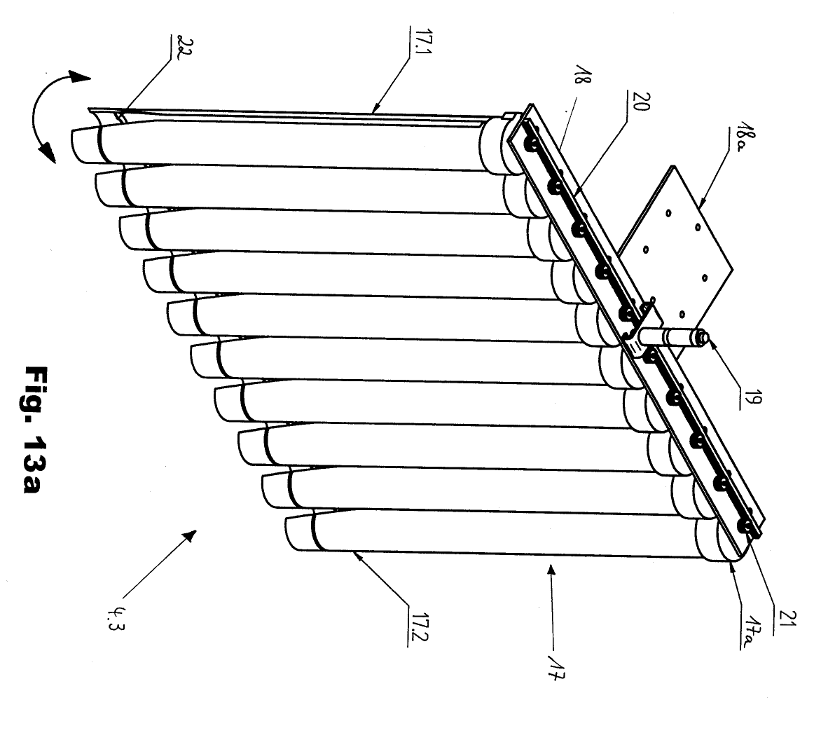

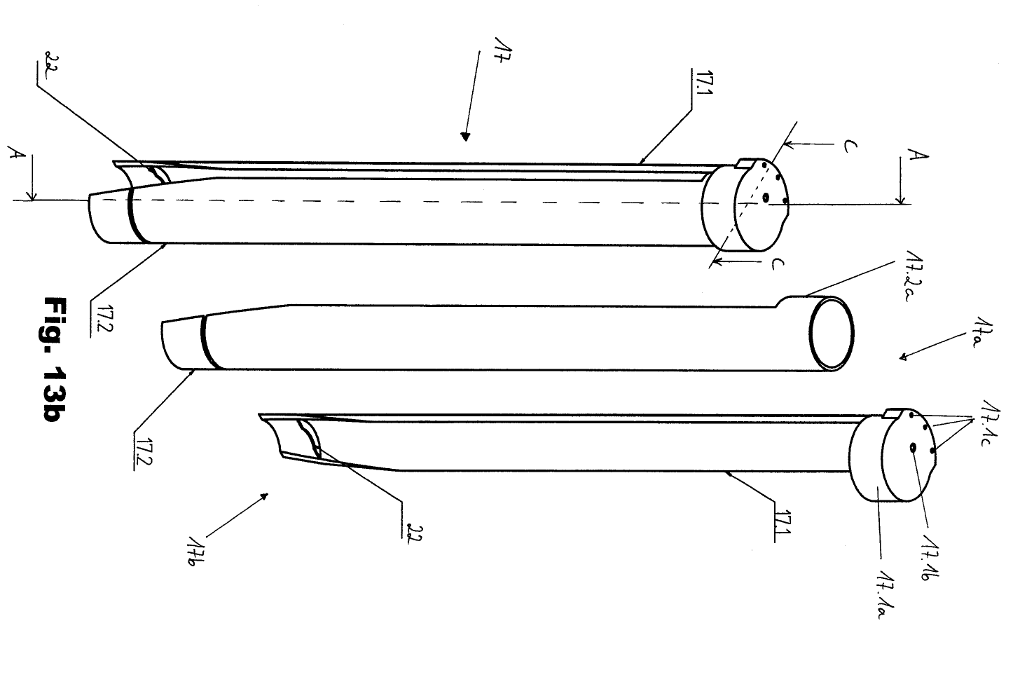

FIG. 12 Diagrammatic representations of a first removal device for objects deposited in the loading aid and removal process performed using the removal device.

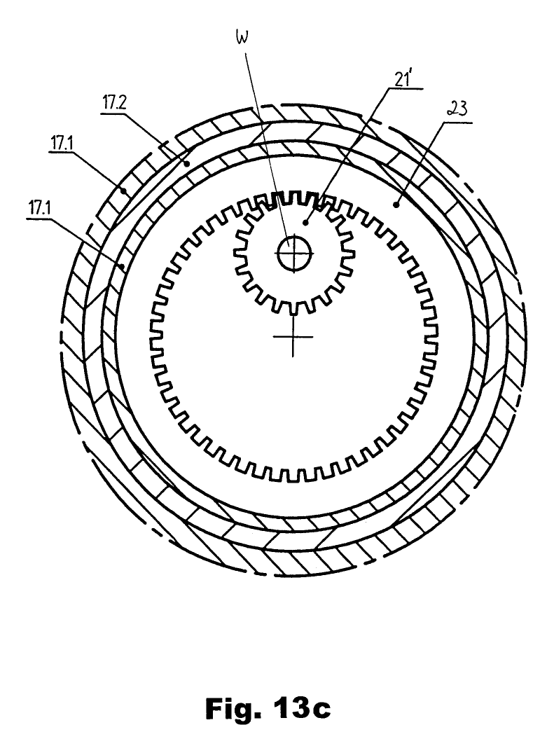

FIG. 13a A further development of the removal device in a perspective overall view.

FIG. 13b Detailed views of a shell arrangement and the partial shells of the removal device of FIG. 13a.

FIG. 13c A sectional representation along line C-C of FIG. 13b.

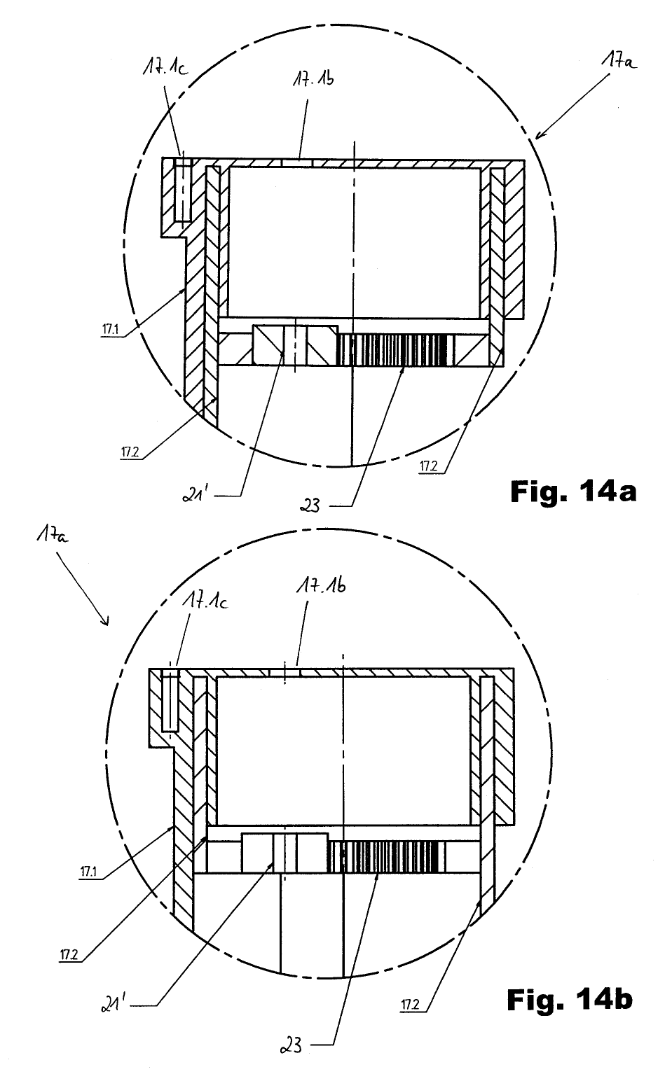

FIG. 14a, b Sectional views along line A-A of FIG. 13b in the opened/closed state of the shell arrangement.

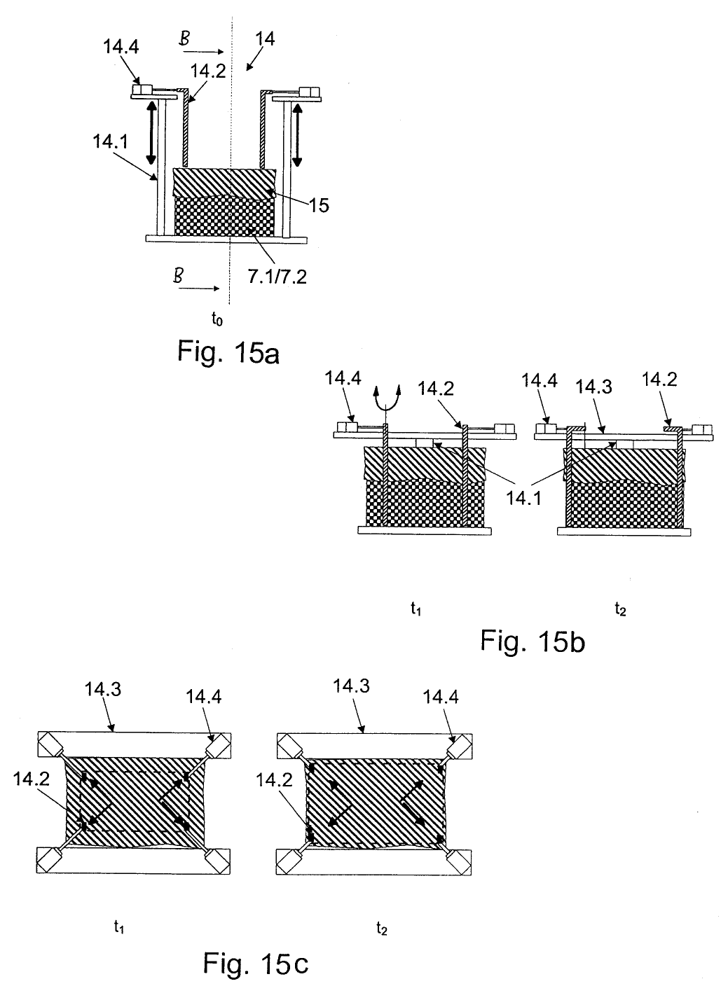

FIG. 15a-c Diagrammatic representations of a develop ment and operation of a spreading station of the inventive device.

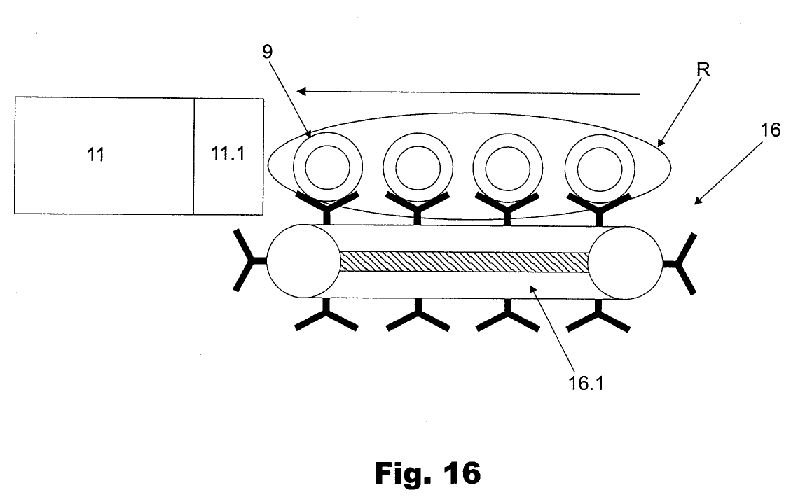

FIG. 16 A diagrammatic representation of a development of magazine means in connection with the further processing of the articles.

FIG. 1 diagrammatically shows a partial view of the inventive device 1 for the manufacture of articles to be handled or rod-shaped objects formed therefrom, specifically in the present case the manufacture of plastic cups for the dairy industry. By means of the represented design of the device, it is possible without setting-up to handle cups with two different diameters. For this purpose the inventive device 1 has a manufacturing device 2 for plastic cups in the form of a deep-drawing machine. In connection with the manufacturing device 2 there are two handling devices 3.1, 3.2 in the form of multiaxial industrial robots, preferably four to six-axial industrial robots, which are in each case equipped with a gripping device 4.1, 4.2. In the work areas A1, A2 of handling devices 3.1, 3.2 are provided tool stations 5.1, 5.2, where the handling devices 3.1, 3.2 can change their gripping device 4.1, 4.2 for adapting to a specific cup diameter. The tool stations 5.1, 5.2 are specifically provided for the aforementioned case of there being two different cup diameters. Otherwise at least one tool station can be omitted. In addition, in work area A2 of handling device 3.2 is provided a conveying means 6 for conveying empty and filled loading aids 7.1, 7.2, e.g. in the form of cardboard boxes or cartons.

Work areas A1, A2 of handling devices 3.1, 3.2 overlap in a partial area A1.2. In the latter are provided according to FIG. 1 magazine means 8, in the specific case in the form of two magazine units 8a, 8a for different cup diameters, for temporarily receiving the objects to be handled, obviating setting-up during a size change.

The fundamental sequence of the inventive method, to the extent that this can be described relative to FIG. 1, is as follows. The manufacturing device 2 manufactures in known manner the plastic cups to be handled from PP or PS in a thermal deep-drawing method. For this purpose a not shown extruded sheet is supplied to the manufacturing device and heated therein. The thermoelastic sheet is then preshaped by preshapers in the manufacturing device and moulded in a mould using compressed air, followed by cooling and blanking. The thus manufactured cups are stacked in one another to form cup poles in manufacturing device 2 and are then made available in an outlet area 2.1 of the latter.

From outlet area 2.1, according to the invention the cup poles are removed by the first handling device 3.1 using the first gripping device 4.1 in a first geometrical arrangement, also called a cavity and having a one or two-dimensional design and supplied to the magazine means 8, where they are temporarily deposited. In the case of modified cup dimensions with the resulting changed dimensions of the cup poles in the outlet area 2.1 of the manufacturing device, the handling device 3.1 moves up to the tool station 5.1 associated therewith and may receive there a new gripping device by means of which it can repeat the hitherto described inventive method without any changed object parameters.

After the first handling device 3.1 has deposited the objects removed from the manufacturing device 2 in magazine means 8, they are removed from there by the second handling device 3.2 using the second gripping device 4.2 operated by it and are deposited in an empty loading aid 7.1 conveyed by conveying means 6 into work area A2 of handling device 3.2. When the loading aid 7.1 is full, it is again removed by conveying means 6 as a full loading aid 7.2 from work area A2 of the second handling device 3.2 and is optionally available for further processing (cf. FIG. 11).

As is diagrammatically intimated in FIG. 1, the outlet area 2.1 of manufacturing device 2 and the magazine means 8 have different geometrical sizes. According to the invention, the objects removed with a first geometrical arrangement at outlet area 2.1 of manufacturing device 2 are deposited by the gripping device 4.1 of the first handling device 3.1 in segment manner in magazine means 8. Then in the magazine means 8 the spacings of the objects are modified, which will be described in greater detail hereinafter. The thus created second arrangement of the objects is such that the second handling device 3.2 by means of its gripping device 4.2 can achieve an optimum packing density of the objects in loading aid 7.1. This is described in greater detail hereinafter relative to FIGS. 6a, 6b, 8 and 9. Alternatively or additionally the modification to the arrangement geometry takes place through the first gripping device 4.1 and the objects are deposited in a second arrangement modified by the gripping device 4.1 of the first handling device 3.1 in magazine means 8.

FIG. 2 diagrammatically shows the reception of the objects to be handled in the form of cup poles 9 by the first gripping device 4.1. In the lower part of the drawing it is possible to see the outlet area 2.1 of manufacturing device 2 (FIG. 1) at different, successive times t₁, t₂, t₃ during the sequence of the method according to the invention. The central area B₁ shows lateral sectional views of the gripping device 4.1 at the same times t₁-t₃, whilst in the upper area B₂ are shown plan views of the gripping device 4.1 at times t₂, t₃.

At t₁ the cup poles 9 of cavity K are moved by plungers 2.2 from outlet area 2.1 of manufacturing device 2 and also over the gripping device 4.1, which can also be called a cavity gripper. This process is ended at time t₂ when the cup poles 9 are in the gripping device 4.1. If the entire cavity K is in the gripping device 4.1, at time t₃ the plungers 2.2 are reinserted and the cup poles 9 are secured in the gripping device 4.1 by a closure means 4.1a, which is described in greater detail hereinafter relative to FIG. 5a, b, c.

In the case of FIG. 2 the cavity K is consequently a two-dimensional arrangement of 5×5 cup poles 9, which are made available with a square geometry at outlet area 2.1 of manufacturing device 2.

FIG. 3a-c are detail views of a group 4.1b of gripping elements 4.1c of gripping device 4.1 (FIGS. 1, 2). These analogously correspond to a group 8.1b of storage elements 8.1c in magazine means 8 (FIG. 1), but in the case of the latter there are no closure means. The four gripping elements 4.1c and storage elements 8.1c shown in FIG. 3a, b are displaceably arranged in a row in the direction of double arrows K along a rail element 4.1d, 8.1d. For this purpose the gripping elements 4.1c (storage elements 8.1c) in the embodiment shown have in their lower area in each case a projection 4.1e, 8.1e with a dovetailed profile engaging in a complimentary groove 4.1f, 8.1f of the rail element 4.1d, 8.1d. It is also possible to have a normal sleeve bearing in place of the aforementioned special profile.

The gripping elements 4.1c and storage elements 8.1c in each case have three guidance means 4.1g, 8.1g, arranged in the form of a triangle, for the cup poles 9 to be received between them (FIG. 2) and which are specifically constructed in the form of poles with a circular cross-section and which extend perpendicular to an extension direction of the rail elements 4.1d, 8.1d and the direction X of the displaceability of gripping elements 4.1c, 8.1c.

In each case adjacent gripping and storage elements 4.1c, 8.1c are interconnected by connecting means 4.1h, 8.1h. Each of the connecting means 4.1h, 8.1h has two elongated holes 4.1i, 4.1i′ and 8.1i, 8.1i′, so that in conjunction with fastening means 4.1j, 8.1j for connecting means 4.1h, 8.1h present on the gripping elements 4.1c (storage elements 8.1c) two extreme spacings d₁, d₂ of the gripping elements 4.1c and storage elements 8.1c are mutually defined.

Thus, as a result of the design and arrangement of the gripping elements 4.1c (storage elements 8.1c) according to FIG. 3a, b it is adequate to provide a single not shown power source acting linearly in the direction of double arrow X in order to modify the spacing of the gripping elements 4.1c (storage elements 8.1c) in simple manner between the first position with a large relative spacing d1 and the second position with a small relative spacing d₂.

FIG. 4 is an overall view of the inventive first gripping device 4.1, in which several groups 4.1b, 4.1b, of gripping elements 4.1c are arranged in the form of adjacent, parallel rows in the case of a two-dimensional arrangement of gripping elements. Within each row it is once again possible to modify the relative spacings of the gripping elements 4.1c in the direction of double arrows X and as in the case of FIG. 3a, b connecting means 4.1h with in each case two elongated holes 4.1i, 4.1i′ for connecting the gripping elements 4.1c of one row. The magazine means 8 of the inventive device can be correspondingly constructed (cf. FIG. 3a-c), which is not shown again here so as not to overburden representation.

Unlike in the case of the developments of the gripping elements 4.1c shown in FIG. 3a, b, in the embodiment according to FIG. 4 they are constructed with a substantially triangular instead of square base 4.1k, the bases 4.1k, 4.1k, of adjacent rows of gripping elements 4.1c being mutually turned by 180° in the plane of the gripping element arrangement, so that in each case a tip or point 4.11 of a base 4.1k of a gripping element 4.1c projects into an also triangular area 4.1m between mutually facing flanks 4.1n, 4.1n′ of adjacent bases 4.1k, 4.1k′ of one row. Thus, the gripping device 4.1 can also grip cavities in which the cup poles 9 are arranged in accordance with an overlapping pattern (cf. FIG. 7b) or an areal, very tight packing.

As a result of the specific design of the first gripping device 4.1, as shown in FIGS. 3a-c and 4, it is possible to grip cavities formed from cup poles 9 with a first relative spacing, e.g. d₁, which is predetermined by manufacturing device 2. Subsequently by simply moving the gripping elements 4.1c it is possible to set a new, generally narrower spacing d₂ of the gripping elements 4.1c and therefore the cup poles 9, which at least within the rows of the gripping device 4.1b corresponds in a substantial manner to the sought optimum packing density of the cup poles 9 in a loading aid (FIG. 1).

The rows of gripping elements 4.1c shown in FIGS. 3a-c and 4 are adapted at their give mutual spacing to a specific geometry of the cavity made available by the manufacturing device 2 (FIG. 1). It e.g. corresponds to the pattern of a tool of the manufacturing device (deep-drawing machine). However, in the case of a change to the geometry, e.g. due to the use of a different tool in the manufacturing device, it can always be correspondingly adapted. As stated regarding FIG. 3a-c, the geometry change can also be displaced from gripping device 4.1 into magazine means 8, so that there is a desirable constructional simplification of the gripping device 4.1.

FIG. 4 shows on a larger scale an upper area 4.1o of a gripping element 4.1c or its guidance means 4.1g and the closure means 4.1a for securing a cup pole 9. The inventive securing of the cup poles is explained hereinafter relative to FIG. 5a-c.

FIG. 5a shows a preferred, possible development of the guidance means 4.1g of gripping elements 4.1c with integrated closure means 4.1a. According to the embodiment shown the closure means 4.1a incorporate a tilting lever 4.1p, which is articulated about an axis S perpendicular to an extension direction of guidance means 4.1g in a not shown terminal recess of the guidance means and is connected to a linkage 4.1q running within the guidance means 4.1g. A downward movement of linkage 4.1q in the direction of the arrows in FIG. 3b, top, brings about an inward pivoting of tilting lever 4.1p, so that its tip 4.1r engages on the inner edge of the lowermost cup 9.1 of a cup pole 9. This is the most stable area of a cup, so that here there is essentially no deformation of cup 9.1 even if it has been only recently manufactured, i.e. is still hot and readily deformable. The upward and downward movement of linkage 4.1q in the direction of the arrows in FIGS. 5a, b (top), c e.g. takes place with the aid of a not shown drive means, e.g. pneumatically or electromotively.

The lower partial representations of FIG. 5a, b show views from below of guidance means 4.1g of the cup poles 9 when the tilting levers 4.1p have been pivoted into cup 9.1 (FIG. 5b, bottom; FIG. 5c, to the right) or pivoted out tilting levers 4.1p (FIG. 5a, bottom; FIG. 5c, to the left).

FIG. 6a shows, how in accordance with the invention, a first geometrical arrangement of the cavity located in gripping device 4.1. can be transformed into a pattern favourable for deposition in a loading aid. In the context of packing logistics “favourable” means that the packing pattern sought in the loading aid involves the maximum number of cup poles therein.

Possible packing patterns are diagrammatically shown in FIG. 7a, b, where there are numerous poles of cups arranged in accordance with a specific pattern and shown in plan view. The cup poles 9 are arranged in rows R, which have a fixed mutual spacing ΔY, whereas the cup poles 9 of a row R have a mutual spacing ΔX. With respect to the area utilization the packing pattern of FIG. 7b is preferable to that of FIG. 7a.

Since in accordance with FIGS. 3a, b and 4 the relative spacings of the gripping elements 4.1c or storage element 8.1c arranged in a row can be adjusted, according to the invention a necessary spacing ΔX of the cup poles 9 within a row R located in the first gripping device 4.1 can be set and e.g. corresponds to the spacing d₂ in FIG. 3b. After the individual rows R of cavity K have been adapted with respect to the spacing ΔX of the cup poles 9 to a spacing amount desired for deposition in the loading aid, row R according to FIG. 6a, left, is deposited in magazine means 8. Alternatively and without a prior spacing change, part of cavity K can be brought into magazine means 8 and the spacing change then takes place in the latter.

In the variant in which the geometry change is carried out solely by the gripping device 4.1, in accordance with the diagrammatic plan views of FIG. 6a at in each case different, successive times t₁-t₆, the magazine means 8 have a two-dimensional arrangement of stable storage elements 8.1′ constructed in such a way that in each case a cup pole 9 can in each case be statically received and retained between two storage elements 8.1′ of magazine means 8 which are adjacent within a row. A side view of magazine means 8 with storage elements 8.1′ and cup poles 9 is shown in FIG. 6b.

At time t₁ a first cavity segment K₁ is deposited by means of the first gripping device 4.1 (not shown in FIG. 6a) in a first area of magazine means 8. The spacings ΔX of cup poles 9 in magazine means 8 correspond to the spacing set by the first gripping device 4.1 and which is suitable for an optimum deposition of the cup poles 9 in a loading aid.

In accordance with the further variant where the spacing change does not take place in gripping device 4.1, at this point the individual storage elements 8.1 of magazine means 8 are displaced for producing the sought packing pattern.

After magazine means 8 has been completely filled with cup poles 9 at time t₃, by means of a further, not shown gripping device the cup poles 9 are received again in rows at magazine means 8 and deposited in loading aid 7.1 (FIG. 1). According to FIG. 6a this takes place at times t₄, t₅, t₆ in each case for one row of cup poles 9 until at time t6 the magazine means 8 is completely emptied again.

The further gripping device (4.2) used according to FIG. 6a for the rowwise reception of the cup poles at times t₄-t₆ comprises the same gripping elements 4.1c as gripping device 4.1 (cavity gripper). A possible difference is that the gripping elements of the further gripping device (row gripper) are not displaceable against one another and that only a single cup pole row can be received and can be longer than the cavity segments K₁-K₃.

FIG. 8 shows the deposition of cup poles 9a-9p in magazine means 8 with corresponding storage elements 8.1′ in the case of a cavity K, within which the cup poles 9a-9p are arranged in overlapping manner in accordance with a corresponding tool of the manufacturing device 2 (FIG. 1). In this case, by means of the gripping device 4.1, whereof only the guidance means 4.1g are shown in FIG. 8, at a first time t₁ only individual rows or row pairs of cup poles 9a-d or 9e-h are deposited in magazine means 8. The handling device 3.1 then displaces the gripping device 4.1, so that at a later time t2 the remaining rows or row pairs of cavity K (cup poles 9i-9l or 9m-9p) can be deposited in the corresponding storage elements 8.1′ of magazine means 8.

The deposition of a cup pole 9 in a loading aid 7.1 is shown in FIG. 9 at three successive times t₁, t₂, t₃. At time t₁ the loading aid 7.1 e.g. a cardboard box, only contains a single row of cup poles 9. Between the individual cup poles 9 it is possible to see the individual guidance and closure means 4.1g, 4.1a of the row gripper. At time t₂ and by means of the row gripper a second row of cup poles 9 is deposited in the loading aid 7.1, deposition taking place in such a way that a relative arrangement of the two rows, particularly with respect to the spacing ΔY, corresponds to the sought optimum packing pattern in the loading aid 7.1 (cf. FIG. 7b). Finally, at time t₃ is shown a loading aid 7.2 completely filled with cup poles 9 in accordance with the sought optimum packing pattern. In order that the cup pole rows deposited in loading aid 7.1 do not tip over prior to the complete filling of the loading aid at time t₃, said loading aid 7.1 is inclined in the direction of arrow N relative to the vertical V, which points of the drawing plane in FIG. 9, so that in particular the first cup pole row can be supported on a wall 7.1a of loading aid 7.1. According to the invention, this takes place in a so-called expanding or spreading station, to be described in greater detail hereinafter relative to FIG. 15. The spreading station is also used for positioning the loading aid 7.1.

FIG. 10 shows the inventive device 1 in connection with the further processing of plastic cups. In the vicinity of a further processing device 11, such as a decorating machine, there are two further handling devices 3.3, 3.4 in the form of industrial robots of the aforementioned type. Within work areas A3 and A4 of handling devices 3.3 and 3.4 are in each case tool stations 5.3, 5.4 and an inlet area 11.1 and an outlet area 11.2 of further processing device 11. The cup poles to be further processed are supplied to work area A3 of handling device 3.3 in filled loading aids 7.2 (FIG. 9) by means of a conveying means 12. As in the case of the above description of the manufacture and subsequent deposition of the objects, with respect to the further processing the loading aids are preferably positioned and inclined by a spreading station (FIG. 15).

The handling device 3.3 has a removal device 4.3 for the cup poles contained in loading aid 7.2. Removal device 4.3 is explained hereinafter relative to FIG. 12 and alternatively relative to FIG. 13a-c, FIG. 14a-c. By means of removal device 4.3 the handling device 3.3 removes cup poles from loading aids 7.2 and makes them available to the further processing device 11 at its inlet area 11.1 for further processing, here for decorating the cups. Following processing in the further processing device 11, the cups in the form of cup poles are gripped again at outlet area 11.2 of further processing device 11 by handling device 3.4 using a gripping device 4.4 essentially corresponding to removal device 4.3 and are again deposited in loading aids 7.1/7.2.

The inlet and outlet area 11.1 and 11.2 of the further processing device 11 are explained hereinafter relative to FIG. 16.

As in the description of FIG. 1, the tool stations 5.3, 5.4 are used for changing removal or gripping devices 4.3, 4.4 in connection with a change to specific cup parameters, such as in particular the cup diameter or the like.

In order to achieve a problem-free removal of cup poles from loading aids 7.2, as stated hereinbefore relative to FIG. 11, also in the case of an optimum tight packing of the cup poles in the loading aids, in connection with the present embodiment of the inventive method and device use is made of a positioning insert 13 within loading aids 7.1/7.2.

A positioning insert of the subsequently described type is particularly necessary if between the dimensions of the optimum packing pattern and the internal dimensions of the loading aid significant variations exist, so that during transportation the objects could diverge excessively from their desired position. Moreover, a positioning insert is always used if cup poles are to be introduced into the loading aid (with the cup opening downwards and protection of the sensitive sealing rim of the cups, avoidance of an interleaving of the cup poles via their circumference surfaces).

An embodiment of the positioning insert 13 is shown diagrammatically in FIG. 11a in section (top) and in plan view (bottom). It is made from a cardboard or plastic material and is placed within the initially empty loading aid 7.1, preferably in its bottom region. According to the invention, prior to the loading of the cup poles in the area of the manufacturing device 2 (FIG. 1), the positioning insert 13 is brought into the loading aid.

In its top side 13.1, the positioning insert 13 has an arrangement of receiving means in the form of projections 13.2, which according to the sought packing pattern of the cup poles are offset in rows. In each case two adjacent projections in a row 13.2′, 13.2″ have on their facing insides 13.3′, 13.3″ recesses 13.4′, 13.4″, whose specific shaping corresponds to a shape of the portion of a circumferential surface of the cups received therein (FIG. 11b). According to the invention the recesses 13.4′, 13.4″ of the inside 13.3′, 13.3″ of projections 13.2, 13.2′, 13.2″ of positioning insert 13 are only located in the upper portions thereof, so that a base 13.5 remains below them through which the cups or cup poles received in recesses 13.4′, 13.4″ can be held in spaced manner from the top 13.1 of positioning insert 13.

FIG. 11b shows a portion of the inventive positioning insert 13 with cup poles 9 received in the recesses of projections 13.2 and formed by nested plastic cups 9.1.

FIG. 11c shows a single reception means 13.2 in perspective. It is in particular possible to see two circular section recesses 13.2a, b for receiving corresponding areas of cups 9.1/cup poles 9.

Through the arrangement of the cup poles 9 in positioning insert 13 the desired optimum packing density of the cup poles is permanently maintained during transportation of the loading aids. In addition, as a result of the permanent, secure arrangement of the cup poles the cup quality is not impaired even if the poles or the cups are still hot and easily deformable because they have only recently been manufactured.

According to FIG. 11b the positioning insert 13 is provided in its marginal area 13.6 with a spacing means 13.7 so as to keep a row of cup poles adjacent to one wall 7.1a of loading aid 7.1 at a distance d from the latter. This aspect is of decisive importance with regards to the design shown in FIGS. 12, 13a-c and 14a-c of removal device 4.3 for cup poles 9 (rows of cup poles 9) from a filled loading aid 7.2 according to FIG. 10. In addition, the positioning insert 13 creates a spacing b of the in each case bottom cup of each cup pole 9 from the bottom 7.2b of loading aid 7.2.

According to a first embodiment shown in FIG. 12, the removal device 4.3 is constructed as a row gripper through which a complete row of cup poles 9 can be taken up from loading aid 7.2. The loading device has for this purpose for each cup pole 9 a hook-like underengaging means 4.3a, which as a result of its dimensions can be introduced into the gap of width d between wall 7.2a of loading aid 7.2 and the adjacent cup poles 9. This is shown at t1 and t2 in FIG. 13. At underengaging means 4.3a is provided a hold-down means 4.3b movable relative thereto and which can be moved up and down by an electric or pneumatic, not shown drive in the direction of the double arrows of FIG. 13. In this way the spacing h between a tip 4.3c of underengaging means 4.3a and hold-down means 4.3b of removal device 4.3 can be adapted to a height H of cup pole 9. This is shown at t3 and t4 after the removal device 4.3 has been brought by the associated handling device 3.3 at least with the tip 4.3c of underengaging means 4.3a into the free space below the cup pole 9 in the vicinity of base 13.5 of positioning insert 13 (FIG. 11a). Hold-down means 4.3b moves downwards until a retaining force or cohesive individually adjustable for each cup type is achieved between the hold-down means 4.3b and the tip 4.3c of underengaging means 4.3a, so that the cup pole 9 is clamped between the tip and the hold-down means. The cup pole 9 or the entire cup pole row can now be removed from the loading aid 7.2 and supplied by handling device 3.3 to the further processing device 11 (FIG. 10).

A further, preferred development of the removal device 4.3 is shown in FIGS. 13a-c, 14a-c and also functions as a row gripper. According to FIG. 13a the removal device 4.3 has for this purpose for each cup pole 9 a substantially circular cylindrical shell arrangement 17 with two half-shells 17.1 and 17.2. The shell arrangements 17 are in a row and are suspended on a common support means 18 in the vicinity of one of their upper ends 17a. The support means 18 has a flange plate 18a for connection to the tool flange of a handling device. FIG. 13a also shows a drive 19 and a rack 20 located on support means 18 and which is operatively connected to the shell arrangements 17 of in each case associated gears 21. Drive 19 is constructed for the movement of the rack 20 in its extension direction. Half-shell 17.1 of shell arrangement 17 is rigid with respect to the gripping device 4.3, whereas half-shell 17.2 is movable and can in particular rotate relative to half-shell 17.1. The rotation of the half-shell 17.2 takes place electrically or pneumatically by means of a not shown power source connected to the drive. By means of the two half-shells 17.1, 17.2 it is possible to almost completely surround the cup poles within the shell arrangement 17.

Shell arrangement 17 and half-shells 17.1, 17.2 are again shown in FIG. 13b. The latter also shows in the lower end region 17b of at least half-shell 17.1 a bearing lip 22 located over the inner circumference of half-shell 17.1 for securing objects to be received in the shell arrangement 17. Preferably half-shell 17.2 also has such a bearing lip 22. In its upper region 17a half-shell 17.1 has an end cap 17.1a with holes 17.1b, c. In its upper region 17a half-shell 17.2 has an annular shoulder 17.2a.

Further details of the inventive removal device 4.3 of FIG. 13a are shown in FIG. 13c by means of a section roughly along line C-C of FIG. 13b. Thus, end cap 17.1a has a double-walled construction and thus embraces shoulder 17.2a. Within cap 17.1a and firmly connected thereto there is also an inner gear 23, which is in meshing engagement with an outer gear 21′, which is preferably located on a common shaft W with the aforementioned gear 21 of removal device 4.3 (FIG. 13a). According to the invention shaft W passes through hole 17.1b (FIG. 13b) and according to FIG. 13a is rotatable by drive 19 via gear 21 and the rotation is transmitted via gears 21′, 23 to the movable half-shell 17.2. The holes 17.1c are used for fixing the half-shell 17.1 (and therefore the shell arrangement 17) to support means 18 (FIG. 13a). Thus, drive 19 simultaneously operates all the shell arrangements 17 functioning as removal devices by means of rack 20 through coupling to gears 21, 21′, 23.

Cup poles are removed in such a way that the removal device 4.3 is located in a position in which the half-shells cover one another, i.e. half-shell 17.2 is in front of half-shell 17.1. In this position handling device 3.3 with removal device 4.3 enters the filled loading aid 7.2. As soon as the removal device 4.3 is completely inserted, i.e. up to the bottom of the loading aid 7.2 or up to the positioning insert 13, half-shell 17.2 is rotated by means of drive 19, so that at the end each individual cup pole is embraced by a shell arrangement 17. For each shell arrangement 17 this corresponds to FIG. 13b, left. Bearing lip 22 is then positioned in such a way that it is below the bottom cup of the cup pole, so that on moving the removal device 4.3 from the loading aid the cup pole is secured. The spacing b of the bottom article of each object from the bottom 7.2b of loading aid 7.2 created by positioning insert 13 (FIG. 11a-c) is of decisive importance.

FIG. 14a, b show further details of removal device 4.3 by means of a longitudinal section along line A-A in FIG. 13b, in each case in a detailed view in the upper area 17a of shell arrangement 17. FIG. 14a shows the opened state of shell arrangement 17, whereas FIG. 14b illustrates the closed state.

Gripping device 4.4 for once again packing cup poles after further processing is, according to the invention, constructed identically to the second gripping device 4.2 or removal device 4.3.

Preferably also on unpacking the cup poles the loading aid is slightly inclined, as described in connection with the packing process. This inclination of the loading aid 7.1, 7.2 takes place, according to the invention, in an expanding or spreading station 14 of the inventive device shown in FIG. 15a-c. This is not shown so as not to overburden representation in FIGS. 1 and 10. The main task of spreading station 14 is to precisely position the loading aids 7.1, 7.2 and in the embodiment shown to spread out the lining 15 contained therein and in particular a plastic bag provided for hygienic reasons in such a way as to apply said bag to the walls 7.1a, 7.2a of the loading aids 7.1, 7.2 that during the insertion and removal of the gripping devices no collision points arise which could damage the lining 15. According to the embodiment shown the spreading station 14 has two telescopic/lifting units 14.1 extendible and retractable in the direction of the double arrows of the first side view of FIG. 15a, between which can be positioned the loading aids 7.1/7.2, together with the lining 15. At the telescopic units 14.1 are provided spreading mandrels 14.2, which are movable diagonally outwards by means of an interposed displacement element 14.3, under the action of suitable drive means 14.4 (cf. FIG. 14c).

FIG. 14b shows positions of the spreading mandrels 14.2 at different times t₁ and t₂. FIG. 14b is a sectional view according to FIG. 14a along line B-B. FIG. 15c shows the same times in a plan view.

As a result of the diagonal displacement of the expanding mandrels 14.2 in the outwards direction the loading aids 7.1/7.2 are positioned in two directions and the lining 15 is spread out and applied to the loading aid walls.

The drive means 14.4 for the telescopic units 14.1 and for the displacement of the expanding mandrels 14.2 can once again e.g. be of an electromotive or pneumatic type.

Finally, FIG. 16 shows further magazine means 16, as used in inlet area 11.1 and outlet area 11.2 of a further processing device 11 according to FIG. 10. The magazine means 16 differ significantly from magazine means 8 in connection with manufacturing device 2 (FIG. 1). In the case of magazine means 16 the cup poles 9 are moved on rowwise in actively timed manner by means of a revolving conveying means 16.1 in order to increase the operational safety and reliability of a further processing device 11, e.g. a decorating machine and are transferred to device 11. Correspondingly FIG. 15 shows a row R formed from four cup poles 9 removed according to the description of FIG. 11 by removal device 4.3 from loading aid 7.2 and then supplied in the direction of the arrow in FIG. 15 by conveying means 16.1 to the inlet area 11.1 of a further processing device 11. According to the invention, an identical arrangement is provided at outlet area 11.2 of the further processing device 11 and is used for supplying the cup pole 9, after further processing has taken place, rowwise to the handling device 3.4 (FIG. 10) for repacking.

1. Method for handling substantially rod-shaped objects, particularly poles of articles individually stacked in one another, such as plastic cups, during loading processes in conjunction with a loading aid, particularly a carton, the objects to be handled being made available in a first geometrical arrangement by a manufacturing or processing machine, characterized in that initially at least part of the objects is gripped, that subsequently a relative mutual arrangement of the objects is modified and that then the modified arrangement of the objects is deposited in the loading aid, the objects being arranged in upright standing manner.

2. Method according to claim 1, characterized in that the objects are gripped by means of a first gripping device and that the change to the object arrangement takes place by modifying a geometry of the first gripping device.

3. (canceled)

4. (canceled)

5. Method according to claim 4, characterized in that the modification to the geometry of the first object arrangement takes place by modifying a spacing of the gripping elements.

6. (canceled)

7. Method according to claim 6, characterized in that an arrangement geometry of the objects is modified in the magazine means.

8. Method according to claim 5, characterized in that the geometry change takes place between a first position predetermined on gripping the objects and a second relative position predetermined by a sought packing density in the loading aid with respect to the gripping elements and/or storage elements.

9. (canceled)

10. (canceled)

11. Method according to claim 9, characterized in that removal takes place rowwise or blockwise.

12. Method according to claim 6, characterized in that a length of the object rows in the magazine means corresponds to a dimension of the loading aid.

13. (canceled)

14. (canceled)

15. Method according to claim 1, characterized in that, following deposition of the objects, the loading aids are stored or conveyed for a further processing of the articles, such as decorating or filling wherein objects are removed rowwise from the loading aid.

16. Method according to claim 15, characterized in that the objects for further processing of the articles are removed from the loading aid by means of a further gripping device (removal device).

17. (canceled)

18. (canceled)

19. Method according to claim 16, characterized in that the objects are removed from the loading aid and then redeposited therein by a common handling device, particularly a multiaxial industrial robot.

20. (canceled)

21. Method according to claim 1, characterized in that the loading aid is inclined relative to the vertical during deposition and/or removal of objects.

22. Method according to claim 20, characterized in that the inclination of the loading aid and the spreading out/application of the lining takes place in a spreading station provided for this purpose.

23. Device for handling substantially rod-shaped objects, particularly poles of articles which can be individually stacked in one another such as plastic cups, following the provision thereof to a corresponding manufacturing or processing machine in a first geometrical arrangement during loading processes in conjunction with a loading aid, particularly a carton, characterized by a first gripping device, which is constructed for gripping at least part of the objects at an interface with the manufacturing or processing machine and for the deposition of the objects in an upright standing manner.

24. Device according to claim 23, characterized in that the first gripping device is constructed for modifying the geometry of the object arrangement prior to deposition in the loading aid.

25. Device according to claim 23, characterized in that there are magazine means for depositing the objects contained in the first gripping device prior to deposition in the loading aid.

26. Device according to claim 25, characterized in that the magazine means is constructed for receiving objects with parallel rod axes in an arrangement of rows.

27. Device according to claim 25, characterized in that the magazine means are constructed for modifying the geometry of the object arrangement.

28. Device according to claim 23, characterized in that the first gripping device has for each object an associated gripping element.

29. Device according to claim 25, characterized in that the magazine means have an associated storage element for each object.

30. Device according to claim 28, characterized in that the gripping elements and/or storage elements have lateral guidance means for the object held.

31. Device according to claim 30, characterized in that in the guidance elements of at least the gripping elements are integrated closure means for retaining the objects.

32. Device according to claim 30, characterized in that the guidance means are constructed for the parallel orientation of the rod axes of objects.

33. Device according to claim 28, characterized in that at least one group of gripping elements is arranged in a row.

34. Device according to 29, characterized in that at least one group of storage elements is arranged in a row.

35. Device according to claim 33, characterized in that at least the gripping elements and/or the storage elements of the group are movably arranged.

36. Device according to claim 35, characterized in that the gripping elements and/or storage elements are movable in a direction perpendicular to the rod axis of the objects held.

37. Device according to claim 33, characterized in that the gripping elements and/or storage elements of the group are slidingly arranged on a rail element extending in the direction of the row.

38. Device according to claim 33, characterized in that a mutual lateral spacing of gripping elements and/or storage elements is variable within the row.

39. Device according to claim 38, characterized in that by means of the lateral spacing it is possible to modify a first position of gripping elements and/or storage elements preset on gripping the objects with respect to a second position of the gripping elements and/or storage elements preset through a sought packing density in the loading aid.

40. Device according to claim 33, characterized in that the gripping elements and/or storage elements of the group are connected by connecting means to the in each case adjacent gripping element/storage element or gripping elements/storage elements (8.1c), through which two relative positions with two different pairwise lateral spacings of gripping elements/storage elements are defined.

41. Device according to claim 40, characterized in that there is an individual power source for moving the gripping elements/storage elements for each group of gripping elements/storage elements.

42. Device according to claim 25, characterized in that there is a second gripping device for removing a second geometrical arrangement of objects from magazine means.

43. (canceled)

44. Device according to claim 23, characterized in that there is a positioning insert in loading aids.

45. Device according to claim 44, characterized in that the positioning insert has reception means for objects into which the latter can be introduced with one of their rod ends.

46. Device according to claim 23, characterized in that there is a further gripping device for removing the objects (removal device) from loading aid.

47. (canceled)

48. Device according to claim 46, characterized in that the removal device for each object to be removed has a shell arrangement formed from at least two half-shells rotatable relative to one another about a common axis for receiving the object, said object being receivable in a space constructed within the shell arrangement and is held therein by retaining means provided at one end of shell arrangement.

49. (canceled)

50. Device according to claim 46, characterized in that the removal device for each object to be removed has a clamping device formed from underengaging means for underengaging the object and a hold-down means for clamping the object between underengaging means and hold-down means.

51. (canceled)

52. (canceled)

53. Device according to claim 23, characterized in that there is a spreading station for spreading out and simultaneously applying a lining, particularly a plastic bag present in the loading aids against the wall of loading aids during the deposition of objects.

54. Device according to claim 53, characterized in that the spreading station is constructed for inclining the loading aids against the vertical during the deposition of objects.

55. Device according to claim 23, characterized in that the first gripping device is operable by a handling device, particularly a multiaxial industrial robot.

56. (canceled)

57. (canceled)

58. (canceled)
